(19) United States
(12) Patent Application Publication
(10) Pub. No.: US 2014/0047990 A1
(43) Pub. Date: Feb. 20, 2014

(54) SCREEN PRINTING APPARATUS, PRINTED MATTER MANUFACTURING METHOD, AND SUBSTRATE MANUFACTURING METHOD

(71) Applicant: Sony Corporation, Tokyo (JP)

(72) Inventor: Masaharu Fujii, Gifu (JP)

(73) Assignee: Sony Corporation, Tokyo (JP)

(21) Appl. No.: 13/957,687

(22) Filed: Aug. 2, 2013

(30) Foreign Application Priority Data
Aug. 16, 2012 (JP) 2012-180684
Jan. 11, 2013 (JP) 2013-004077

(51) Int. Cl. B41F 15/12

(52) U.S. Cl. CPC B41F 15/12
USPC 101/123; 101/129

(57) ABSTRACT

A screen printing apparatus includes a screen moving mechanism and a controller. The screen moving mechanism is configured to move a screen including a patterned hole, the patterned hole being used for printing a paste-like material on a printing substrate. The controller is configured to control the screen moving mechanism to move the screen to a position corresponding to a size of the printing substrate in accordance with a change in size of the printing substrate.

### CROSS REFERENCES TO RELATED APPLICATIONS

The present application claims priority to Japanese Priority Patent Application JP 2012-180684 filed in the Japan Patent Office on Aug. 16, 2012, JP 2013-004077 filed in the Japan Patent Office on Jan. 11, 2013, the entire content of which is hereby incorporated by reference.

### BACKGROUND

The present disclosure relates to a technology of a screen printing apparatus that prints a paste-like material on a printing substrate via a patterned hole provided on a screen, and the like.

From the past, a screen printing apparatus that prints a paste-like material such as cream solder and an ink on a printing substrate such as a substrate, paper, a cloth, wood, and plastic by screen printing has been widely known.

In such a screen printing apparatus, a squeegee is disposed above a screen on which a patterned hole is provided, and a printing substrate is disposed below the screen. A paste-like material is supplied onto the screen, and the squeegee slides on the screen. When the squeegee slides on the screen, the paste-like material is printed on the printing substrate disposed under the patterned hole.

It is necessary for the screen printing apparatus to align a position of the screen with a position of the printing substrate. As methods of aligning the screen with the printing substrate, a method of moving the printing substrate and a method of moving the screen are known.

Japanese Patent Application Laid-open No. Hei 06-182965 discloses a method of moving a screen and aligning the screen with a substrate. In the technology disclosed in Japanese Patent Application Laid-open No. Hei 06-182965, first, a reference mark provided on the screen is detected by a position detection mechanism so that a position of the screen is recognized. Next, a reference mark provided on the substrate is detected so that a position of the substrate is recognized.

Next, based on those two positions, a positional shift amount between the screen and the substrate is calculated. Then, in order to correct the positional shift between the screen and the substrate, the screen is moved in the X, Y, and θ directions. Upon completion of the alignment in the X, Y, and θ directions, the substrate is raised and comes into contact with a lower surface of the screen. Then, a squeegee slides on the screen. Thus, cream solder is printed on the substrate.

The screen may be configured to be replaceable with respect to the screen printing apparatus. For example, a plurality of types of screens are prepared in accordance with the size of the printing substrate. In the case where an operator replaces a screen, the operator removes the screen attached to the screen printing apparatus and thereafter attaches a new screen that corresponds to the size of a printing substrate to the screen printing apparatus.

### SUMMARY

The position where the screen is disposed within the screen printing apparatus may be changed in accordance with a change in size of the printing substrate. In the past, an operator manually has performed such an adjustment of the position where the screen is disposed. Such an adjustment is bothersome for the operator.

In view of the circumstances as described above, it is desirable to provide a technology capable of automatically moving a screen to an appropriate position corresponding to the size of a printing substrate, when the screen is replaced.

According to an embodiment of the present disclosure, there is provided a screen printing apparatus including a screen moving mechanism and a controller.

The screen moving mechanism is configured to move a screen including a patterned hole, the patterned hole being used for printing a paste-like material on a printing substrate.

The controller is configured to control the screen moving mechanism to move the screen to a position corresponding to a size of the printing substrate in accordance with a change in size of the printing substrate.

In the screen printing apparatus, the screen is automatically moved to an appropriate position corresponding to the size of the printing substrate. Thus, time and effort for position adjustment of the screen by a user is omitted, thus improving user-friendliness.

In the screen printing apparatus, the controller may be configured to move the screen to the position corresponding to the size of the printing substrate and then move the screen by the screen moving mechanism to align a position at which the patterned hole is provided, with a reference position serving as a reference at which the printing substrate is disposed.

In such a manner, the position of the patterned hole and the reference position of the printing substrate are aligned in advance, and therefore time spent for alignment of the patterned hole and the substrate can be shortened.

In the screen printing apparatus, the screen may include an alignment mark.

In this case, the screen printing apparatus may further include an imaging unit capable of imaging the alignment mark of the screen.

In this case, the controller may be configured to align the position at which the patterned hole is provided, with the reference position, based on an image of the alignment mark of the screen.

Thus, the position of the patterned hole and the reference position of the printing substrate can be appropriately aligned with each other.

In the screen printing apparatus, the printing substrate may include an alignment mark.

The screen printing apparatus may further include an imaging unit capable of imaging the alignment mark of the printing substrate.

The controller may be configured to move the screen based on an image of the alignment mark of the printing substrate, the position of the patterned hole of the screen being aligned with the reference position, and to align the position of the patterned hole with the position of the printing substrate.

Thus, the position of the patterned hole and the reference position of the printing substrate can be appropriately aligned with each other. It should be noted that the screen is moved from the state where the position of the patterned hole and the reference position of the printing substrate are aligned with each other in advance, and therefore time spent for alignment of the patterned hole and the substrate can be shortened, as described above.

The screen printing apparatus may further include a pair of guides and a guide moving mechanism.

The pair of guides are configured to extend along a conveying direction in which the printing substrate is conveyed and to guide the printing substrate along the conveying direction.

The guide moving mechanism is configured to move at least one of the pair of guides in a direction perpendicular to the conveying direction.

In this case, the controller may be configured to control the guide moving mechanism to move the at least one of the pair of guides in accordance with the change in size of the printing substrate and to control the screen moving mechanism to move the screen to the position corresponding to the size of the printing substrate.

Thus, the pair of guides and the screen can be moved to an appropriate position in accordance with the change in size of the printing substrate.

The screen printing apparatus may further include a cleaning unit and a cleaning-unit-moving mechanism.

The cleaning unit is configured to clean the screen.

The cleaning-unit-moving mechanism is configured to move the cleaning unit in a predetermined direction.

In this case, the controller may be configured to move, when the screen is cleaned, the screen in a direction perpendicular to a direction in which the cleaning unit is moved, to dispose the screen at two or more different positions, and to move the cleaning unit by the cleaning-unit-moving mechanism in the predetermined direction in a state where the screen is located at each of the two or more different positions to clean the screen.

In the screen printing apparatus, even when the cleaning unit is small for the size of the screen, the screen can be cleaned using a cleaning unit with a small size.

In the screen printing apparatus, the screen moving mechanism may include a table, a pair of screen holding members, a width adjusting mechanism, and a table driving unit.

The pair of screen holding members are provided on a lower side of the table so as to face each other in a width direction and are configured to hold the screen.

The width adjusting mechanism is located between the table and the pair of screen holding members and is configured to adjust a distance between the pair of screen holding members in the width direction.

The table driving unit is provided on an upper side of the table and is configured to drive the table.

In the screen printing apparatus, the pair of screen holding members and the width adjusting mechanism are provided on the lower side of the table. Further, the table driving unit that drives the table is provided on the opposite, upper side of the table. Thus, the interference between the table driving unit and the pair of screen holding members and width adjusting mechanism can be avoided. Thus, the screen printing apparatus can be downsized with increase in a moving distance of the table by the table driving unit and a moving distance of the pair of screen holding members in the width direction by the width adjusting mechanism.

In the screen printing apparatus, the width adjusting mechanism may include a width adjusting rail that is attached to a lower surface of the table along the width direction.

In this case, the table driving unit may include a first table driving rail. The first table driving rail is attached to an upper surface of the table along a perpendicular direction and is located at a position crossing the width adjusting rail on the upper side of the table, the perpendicular direction being perpendicular to the width direction, the width adjusting rail being attached to the lower surface of the table.

In the screen printing apparatus, the width adjusting rail attached to the lower surface of the table and the first table driving rail attached to the upper surface of the table are located at positions crossing each other on the lower and upper surfaces of the table. In other words, in the screen printing apparatus according to an embodiment of the present disclosure, the table driving unit is provided on the upper side of the table, and therefore the width adjusting rail and the first table driving rail can be disposed at positions crossing each other on the lower and upper surfaces of the table. Thus, the screen printing apparatus can be downsized with increase in a moving distance of the table in the perpendicular direction by the table driving unit and a moving distance of the pair of screen holding members in the width direction by the width adjusting mechanism.

The screen printing apparatus may further include a plate member that is provided above the table.

In this case, the table driving unit may include a first table drive mechanism.

The first table drive mechanism includes the first table driving rail, a first slide member, a second table driving rail, a second slide member, and a rotating body.

The first table driving rail is attached to the upper surface of the table along the perpendicular direction.

The first slide member is slidable along the first table driving rail.

The second table driving rail is attached to a lower surface of the plate member along the width direction.

The second slide member is slidable along the second table driving rail.

The rotating body is configured to relatively rotate the first slide member and the second slide member.

In the screen printing apparatus, the table driving unit may include a second table drive mechanism.

The second table drive mechanism includes a third table driving rail, a third slide member, a fourth table driving rail, a fourth slide member, and a rotating body.

The third table driving rail is attached to the upper surface of the table along the width direction.

The third slide member is slidable along the third table driving rail.

The fourth table driving rail is attached to the lower surface of the plate member along the perpendicular direction.

The fourth slide member is slidable along the fourth table driving rail.

The rotating body is configured to relatively rotate the third slide member and the fourth slide member.

According to another embodiment of the present disclosure, there is provided a screen printing apparatus including a screen moving mechanism and a controller.

The screen moving mechanism is configured to move a screen including a patterned hole, the patterned hole being used for printing a paste-like material on a printing substrate.

The controller is configured to move the screen by the screen moving mechanism to align a position at which the patterned hole is provided, with a reference position serving as a reference at which the printing substrate is disposed.

According to another embodiment of the present disclosure, there is provided a printed matter manufacturing method including: controlling a screen moving mechanism to move a screen to a position corresponding to a size of a printing substrate, the screen including a patterned hole used for printing a paste-like material on the printing substrate; and moving a squeegee to slide on the screen, to print a paste-like material on the printing substrate.

According to another embodiment of the present disclosure, there is provided a printed matter manufacturing method including: moving a screen by a screen moving mechanism, the screen including a patterned hole used for printing a paste-like material on a printing substrate, to align a position at which the patterned hole is provided, with a reference position serving as a reference at which the printing substrate is disposed; and moving a squeegee to slide on the screen, to print a paste-like material on the printing substrate.

According to another embodiment of the present disclosure, there is provided a substrate manufacturing method including: controlling a screen moving mechanism to move a screen to a position corresponding to a size of a substrate, the screen including a patterned hole used for printing cream solder on the substrate; moving a squeegee to slide on the screen, to print the cream solder on the substrate; and mounting an electronic component on the substrate on which the cream solder is printed.

According to another embodiment of the present disclosure, there is provided a substrate manufacturing method including: moving a screen by a screen moving mechanism, the screen including a patterned hole used for printing cream solder on a substrate, to align a position at which the patterned hole is provided, with a reference position serving as a reference at which the substrate is disposed; moving a squeegee to slide on the screen, to print the cream solder on the substrate; and mounting an electronic component on the substrate on which the cream solder is printed.

As described above, according to the present disclosure, it is possible to provide a technology capable of automatically moving a screen to an appropriate position corresponding to the size of a printing substrate, when the screen is replaced.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a perspective view showing a screen printing apparatus according to an embodiment of the present disclosure;

FIG. 2 is a top view showing an example of a screen of the screen printing apparatus;

FIG. 3 is a block diagram showing a configuration of the screen printing apparatus;

FIG. 4 is a perspective view showing a Y-axis drive mechanism;

FIG. 5 is a perspective view for describing a basic operation of the screen printing apparatus;

FIG. 6 is a perspective view for describing a basic operation of the screen printing apparatus;

FIG. 7 is a flowchart of an operation of the screen printing apparatus when the screen is replaced;

FIG. 8 is a top view showing another example of the screen;

FIG. 9 is a flowchart of an operation of a screen printing apparatus according to another embodiment;

FIG. 10 is a diagram for describing an alignment by a screen printing apparatus according to another embodiment;

FIG. 11 is a diagram for describing an alignment by a screen printing apparatus according to a comparative example;

FIG. 12 is a perspective view showing a screen moving mechanism of a screen printing apparatus according to still another embodiment of the present disclosure; and

FIG. 13 is a perspective view showing a screen moving mechanism of the screen printing apparatus according to the still another embodiment of the present disclosure.

### DETAILED DESCRIPTION

Hereinafter, embodiments according to the present disclosure will be described with reference to the drawings.

(Overall Configuration of Screen Printing Apparatus 100 and Configurations of Respective Units)

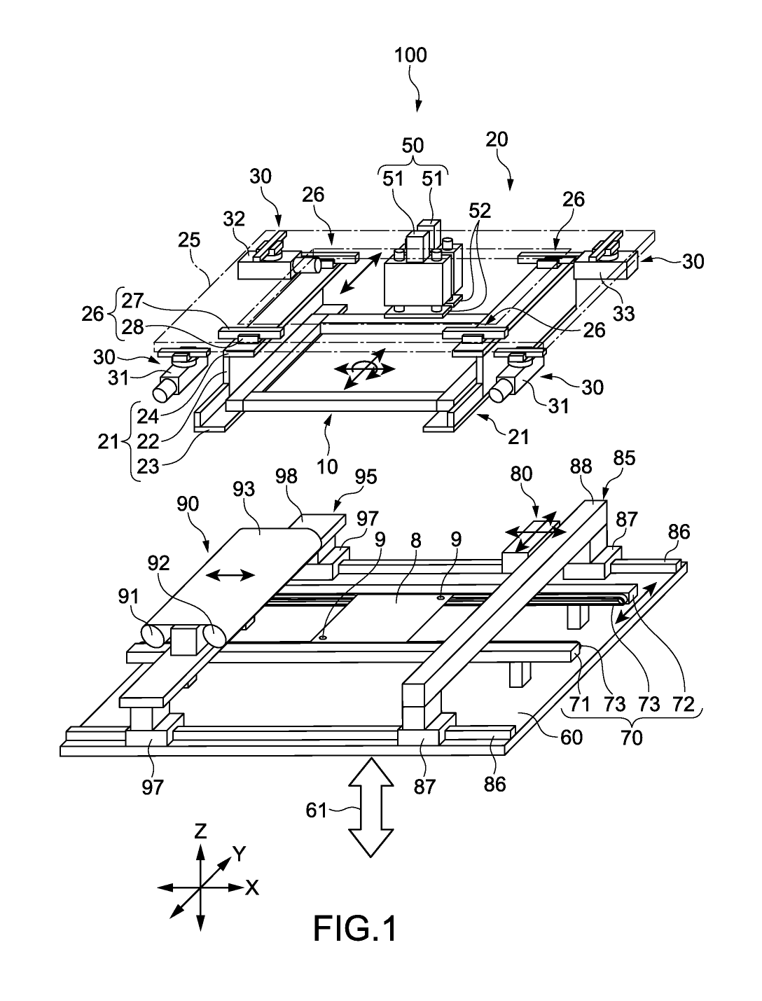

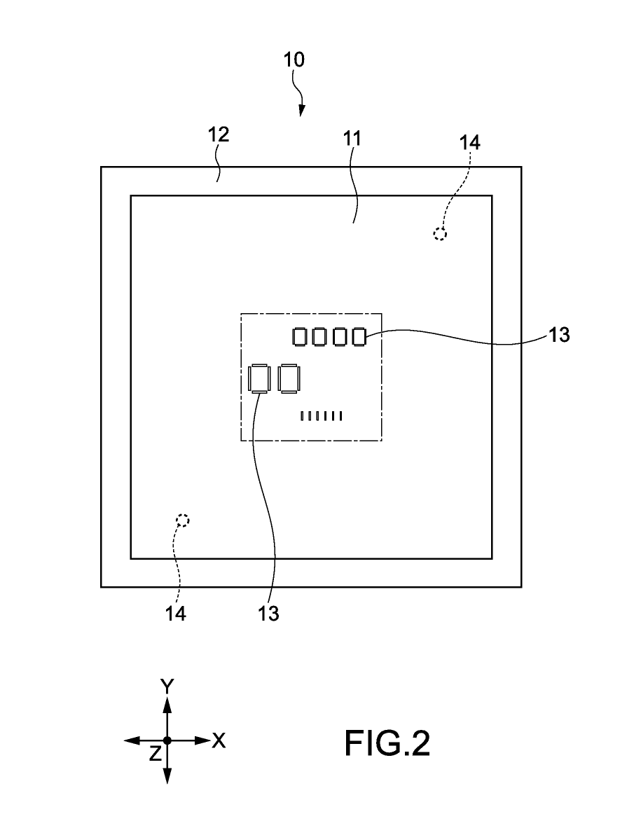

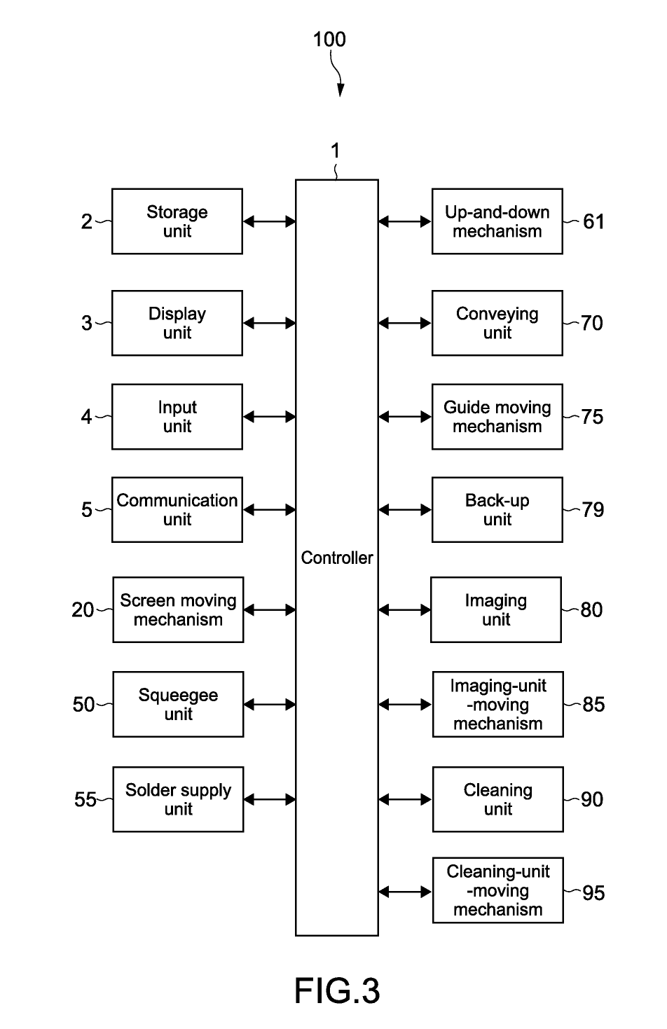

FIG. 1 is a perspective view showing a screen printing apparatus 100 according to an embodiment of the present disclosure. FIG. 2 is a top view showing an example of a screen 10 of the screen printing apparatus 100. FIG. 3 is a block diagram showing a configuration of the screen printing apparatus 100.

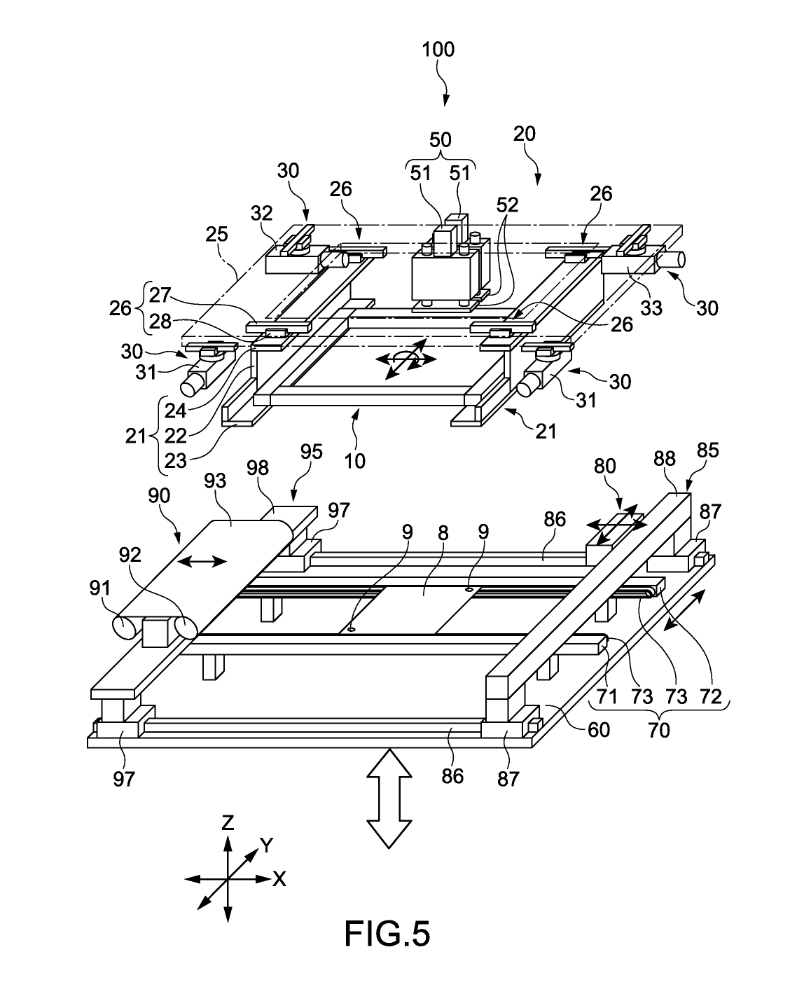

In each view described herein, the size and the like of each unit of the screen printing apparatus 100 may be different from the actual size and the like in order to be easily seen. In particular, in FIG. 1, in order to be easily seen, a distance between the screen 10 (upper side) and a conveying unit 70 (lower side) is larger than an actual distance (the same holds true for FIG. 5 to be described later).

The screen printing apparatus 100 shown in those figures is a screen printing apparatus 100 configured to print cream solder (paste-like material) on a substrate 8 (printing substrate). The screen printing apparatus 100 is arranged in a mounting line in which a circuit board is manufactured. The screen printing apparatus 100 forms a part of the mounting line.

On the upstream side of the screen printing apparatus 100, for example, a substrate loading apparatus that loads the substrate 8 into the screen printing apparatus 100 is arranged. On the other hand, on the downstream side of the screen printing apparatus 100, a printing inspection apparatus, a mounting apparatus, and the like are arranged.

The printing inspection apparatus receives the substrate 8 (printed matter) on which cream solder is printed, from the screen printing apparatus 100, and inspects a printing condition of the cream solder. The printing inspection apparatus transfers the substrate 8 whose printing condition is determined to be good to the mounting apparatus arranged on the downstream side. The mounting apparatus receives the substrate 8 whose printing condition is determined to be good from the printing inspection apparatus, and mounts an electronic component onto the substrate 8. Thus, a plurality of substrates 8 are manufactured sequentially.

With reference to the upper side of FIG. 1, the screen printing apparatus 100 according to this embodiment includes a screen 10, a screen moving mechanism 20 for moving the screen 10, a squeegee unit 50, and a solder supply unit 55 that supplies cream solder onto the screen 10 (see FIG. 3).

With reference to the lower side of FIG. 1, the screen printing apparatus 100 includes an up-and-down base 60 and an up-and-down mechanism 61 that moves up and down the up-and-down base 60. The screen printing apparatus 100 further includes the conveying unit 70 that conveys the substrate 8, and a back-up unit 79 that supports the substrate 8 from below (see FIG. 3). Further, the screen printing apparatus 100 includes an imaging unit 80, an imaging-unit-moving mechanism 85 that moves the imaging unit 80, a cleaning unit 90 that cleans a lower surface of the screen 10, and a cleaning-unit-moving mechanism 95 that moves the cleaning unit 90.

With reference to FIG. 3, the screen printing apparatus 100 further includes a controller 1, a storage unit 2, a display unit 3, an input unit 4, a communication unit 5, and the like.

With reference to FIG. 2, the screen 10 includes a screen body 11 and a screen frame body 12. The screen body 11 is rectangular in shape. The screen frame body 12 is provided along the four sides of the screen body 11 and imparts a tensile force to the screen body 11. The screen body 11 is made of metal such as stainless steel, for example.

The screen body 11 includes a plurality of patterned holes 13, which correspond to a printing pattern, at the center area of the screen body 11. Further, two alignment marks 14 are provided near corner portions on a diagonal line of the screen body 11.

In this embodiment, the imaging unit 80 is disposed below the screen 10, and therefore the alignment marks 14 are provided to the lower side of the screen body 11. It should be noted that the alignment marks 14 may be provided to the upper side of the screen body 11. In the example shown in FIG. 2, the number of alignment marks 14 is set to two, but the number of alignment marks 14 is not particularly limited as long as the number is two or more.

The screen 10 is replaceable with respect to the screen printing apparatus 100 and is replaced in accordance with a change in type (size) of the substrate 8. In other words, in this embodiment, a plurality of types of screens 10 corresponding to the type (size) of substrates 8 are prepared. Those various types of screens 10 are different from one another in pattern shape and size of the patterned holes 13. Further, the size of the screens 10 may also differ (for example, large size, medium size, and the like).

With reference to the upper side of FIG. 1, the screen 10 is held by the screen moving mechanism 20 so that the screen 10 is movable. The screen moving mechanism 20 moves the screen 10 in X, Y, and θ directions in order to align the screen 10 with the substrate 8. Further, the screen moving mechanism 20 moves the screen 10 to a position corresponding to the size of the substrate 8 in accordance with a change in size of the substrate 8. In other words, the screen moving mechanism 20 can move the screen 10 in a wider range than a moving distance for aligning the screen 10 with the substrate 8.

The movable range of the screen 10 by the screen moving mechanism 20 is set in accordance with the size of various types of substrates 8. For example, in the case where the width (Y-axis direction) of the substrate 8 is in the range of 5 cm to 55 cm, the movable range of the screen 10 in the Y-axis direction is set to at least 25 cm (=(55 cm−5 cm)/2).

The screen moving mechanism 20 includes two screen holding members 21, a table 25, and a table driving unit 30. The two screen holding members 21 hold the screen 10. The table 25 supports the two screen holding members 21 from above. The table driving unit 30 moves the table 25 in the X, Y, and θ directions. In FIG. 1, in order to be easily viewable, the table 25 is indicated by a dashed line.

The screen holding members 21 are each made of a metal plate, for example, and detachably hold the screen 10. The screen holding members 21 are formed symmetrically in an X-axis direction and are disposed at positions at which the screen 10 is sandwiched from both sides in the X-axis direction. The screen 10 is slidable on the screen holding members 21 along the Y-axis direction.

Each of the screen holding members 21 includes a side plate 22, a lower plate 23, and an upper plate 24. The lower plate 23 is attached vertically to the side plate 22 at a lower position of the side plate 22. The upper plate 24 is attached vertically to the side plate 22 at an upper position of the side plate 22.

Though not illustrated, the screen printing apparatus 100 includes a clamping member for fixing the screen 10 to the screen holding members 21. The clamping member sandwiches the screen frame body 12 and the lower plates 23 of the screen holding members 21 in the vertical direction for clamping. The clamping member has a mechanism such as a cylinder and can automatically clamp the screen frame body 12 and the screen holding members 21 by the drive of the cylinder.

A width adjusting mechanism 26 for adjusting a distance between the two screen holding members 21 is provided between the screen holding members 21 and the table 25. The width adjusting mechanism 26 includes four guide rails 27 and four slide members 28 that engage with those four guide rails 27. The four guide rails 27 are fixed to a lower surface of the table 25 along the X-axis direction. The four slide members 28 are fixed to the upper plates 24 of the screen holding members 21, guided by the guide rails 27, and moved along the X-axis direction.

The width adjusting mechanism 26 includes a drive system such as a ball screw mechanism (not shown). By the drive of this drive system, the slide members 28 are moved along the X-axis direction. Thus, the distance between the screen holding members 21 is automatically adjustable. For example, in the case where the screen 10 currently attached is replaced with a screen 10 whose entire size is different from that of the attached screen 10, the distance between the screen holding members 21 is adjusted in the X-axis direction.

The table 25 can support the screen holding members 21 from above. At the center of the table 25, an opening for disposing the squeegee unit 50 is provided.

The squeegee unit 50 includes two squeegee mechanisms 51 formed symmetrically in the Y-axis direction. Further, the squeegee unit 50 includes a Y-axis moving mechanism for moving the two squeegee mechanisms 51 integrally in the Y-axis direction, an up-and-down moving mechanism for moving the squeegee mechanisms 51 in an up-and-down direction, and the like.

The two squeegee mechanisms 51 each include a squeegee 52 at a lower side thereof. The squeegee 52 slides on the screen 10, to which cream solder is supplied, toward the Y-axis direction, and prints the cream solder on the substrate 8 provided below the screen 10 via the patterned holes 13 provided to the screen 10.

When one of the squeegee mechanisms 51 is sliding on the screen 10, the other squeegee mechanism 51 is located above the screen 10 and is not brought into contact with the screen 10. A squeegee mechanism 51 to slide on the screen 10 (that is, a squeegee mechanism 51 to perform printing) is alternately switched.

Though not illustrated, the Y-axis moving mechanism that moves the two squeegee mechanisms 51 in the Y-axis direction is vertically provided on the table 25. Therefore, when the table 25 or the screen 10 is moved in the X, Y, and θ directions by the table driving unit 30, along with this operation, the squeegee unit 50 is also moved in the X, Y, and θ directions.

The table driving unit 30 serving as a drive source for moving the screen 10 in the X, Y, and θ directions includes two Y-axis drive mechanisms 31, one X-axis drive mechanism 32, and one interlocking mechanism 33. Those four mechanisms 31, 32, and 33 are disposed near the four corner portions of the table 25 on the lower side of the table 25.

The two Y-axis drive mechanisms 31 are disposed near two corner portions on the front side of the table 25. The X-axis drive mechanism 32 is disposed near a corner portion on the rear left side of the table 25. The interlocking mechanism 33 is disposed near a corner portion on the rear right side of the table 25. It should be noted that the positions where those four mechanisms are disposed can be changed as appropriate. For example, the two Y-axis drive mechanisms 31 may be disposed on the rear side, and the X-axis drive mechanism 32 and the interlocking mechanism 33 may be disposed on the front side. Alternatively, the X-axis drive mechanism 32 and the interlocking mechanism 33 may be positioned vice versa.

The four mechanisms 31, 32, and 33 are each fixed to a column (not shown) and the like, and support the table 25 from below while being fixed to the column. The Y-axis drive mechanisms 31 support the table 25 from below and move the table 25 in the Y-axis direction by the drive of the Y-axis drive mechanisms 31. The X-axis drive mechanism 32 supports the table 25 from below and moves the table 25 in the X-axis direction by the drive of the X-axis drive mechanism 32. Further, the Y-axis drive mechanisms 31 and the X-axis drive mechanism 32 can rotate the table 25 about a Z-axis direction (A direction) by the interlock of those drive mechanisms.

It should be noted that the interlocking mechanism 33 does not include a drive source for moving the table 25. The interlocking mechanism 33 supports the table 25 from below and operates in conjunction with the drive of the table 25 by the Y-axis drive mechanisms 31 and the X-axis drive mechanism 32.

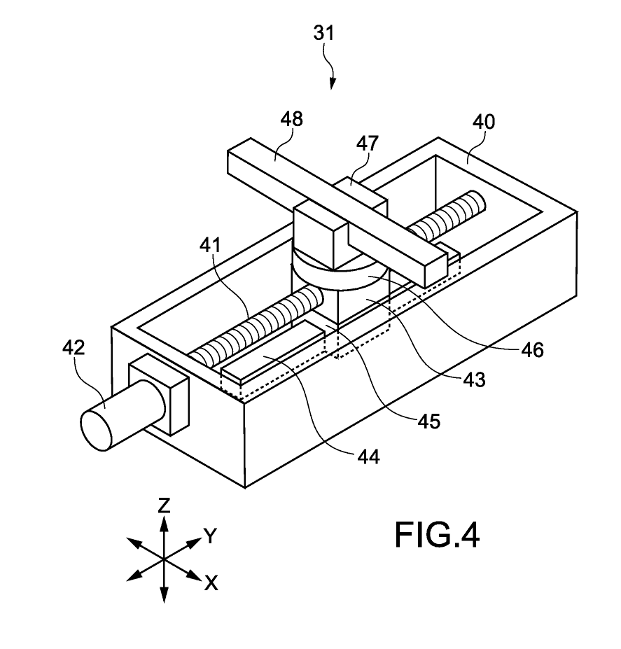

FIG. 4 is a perspective view showing the Y-axis drive mechanism 31. The Y-axis drive mechanism 31 and the X-axis drive mechanism 32 have the same configuration of the drive mechanism itself, though being attached to the table 25 in different orientations. Therefore, here, the Y-axis drive mechanism 31 will be described as a representative example.

As shown in FIG. 4, the Y-axis drive mechanism 31 includes a casing 40 that is long in the Y-axis direction and whose upper side is opened. Further, the Y-axis drive mechanism 31 includes a ball screw 41 and a motor 42. The ball screw 41 is disposed along the Y-axis direction across the inside of the casing 40. The motor 42 serves as a drive source to rotate the ball screw 41. The motor 42 is attached to the outside of the casing 40.

On the inner bottom surface of the casing 40, a first guide rail 44 is provided along the Y-axis direction. On the first guide rail 44, a first slide member 45 that is slidable on the first guide rail 44 is provided. On the first slide member 45, a ball screw nut 43 is disposed. The ball screw nut 43 engages with the ball screw 41 and moves in the Y-axis direction in accordance with the rotation of the ball screw 41.

On the ball screw nut 43, a rotating body 46 attached to the ball screw nut 43 so as to be rotatable about the Z-axis direction is disposed. Since this rotating body 46 is rotatable about the Z-axis direction, the table can rotate about the Z-axis direction.

A second slide member 47 is disposed on the rotating body 46, and a second guide rail 48 is disposed on the second slide member 47. The upper surface of the second guide rail 48 is fixed to the lower surface of the table 25.

Here, the interlocking mechanism 33 has a similar configuration as the Y-axis drive mechanism 31 shown in FIG. 4. The interlocking mechanism 33 is different from the Y-axis drive mechanism 31 in that the interlocking mechanism 33 does not include a drive system such as the motor 42 and the ball screw 41. In the other components, the interlocking mechanism 33 has a similar configuration as the Y-axis drive mechanisms 31 and the X-axis drive mechanism 32.

For example, when the X-axis drive mechanism 32 is driven in a state where the two Y-axis drive mechanisms 31 are not driven, the table 25 is moved in the X-axis direction. Further, when the two motors 42 of the two Y-axis drive mechanisms 31 are simultaneously rotated by an equal rotation amount in a state where the X-axis drive mechanism 32 is not driven, the table 25 is moved in the Y-axis direction. When the two motors 42 of the two Y-axis drive mechanisms 31 are driven so as to have different rotation amounts and rotation directions, the table 25 is rotated about the Z-axis direction (θ direction).

With reference to the lower side of FIG. 1, the conveying unit 70 includes a first guide 71, a second guide 72, conveyer belts 73, and a guide moving mechanism 75 (see FIG. 3). The first guide 71 and the second guide 72 extend along the X-axis direction (conveying direction) and guide a substrate along the X-axis direction. The conveyer belts 73 are provided on an inner surface side of the first guide 71 and on an inner surface side of the second guide 72.

The substrate 8 is disposed on the conveyer belts 73 and moved by the drive of the conveyer belts 73 along the X-axis direction while being guided by the first guide 71 and the second guide 72. The conveying unit 70 can load the substrate 8 and perform positioning of the substrate 8 at a reference position or transfer the substrate 8 that has been subjected to printing to another apparatus by the drive of the conveyer belts 73.

The guide moving mechanism 75 moves at least one of the first guide 71 and the second guide 72 in the Y-axis direction (in a direction perpendicular to the conveying direction). It should be noted that in this embodiment, the second guide 72 (on the rear side) of the two guides is moved in the Y-axis direction and the first guide 71 (on the front side) is fixed.

By the movement of the second guide 72 by the guide moving mechanism 75, the conveying unit 70 can sandwich the substrate 8, which is conveyed to a reference position, from both sides to be fixed, or can adjust a distance between the guides 71 and 72 in accordance with the size of the substrate 8. For example, in the case where the width (Y-axis direction) of the substrate 8 is in the range of 5 cm to 55 cm, the movable range of the second guide 72 in the Y-axis direction is set to at least 50 cm.

A reference position at which the substrate 8 is disposed to be subjected to screen printing is set to a position near the center of the conveying unit 70, for example. At the reference position, the back-up unit 79 (see FIG. 3) that supports the substrate 8 from below is disposed. The back-up unit 79 supports the substrate 8 from below after the substrate 8 is conveyed to the reference position by the drive of the conveyer belts 73. In this state, cream solder is printed on the substrate 8.

The imaging-unit-moving mechanism 85 that moves the imaging unit 80 in the X and Y directions is provided on the up-and-down base 60. The imaging-unit-moving mechanism 85 includes, on the up-and-down base 60, two guide rails 86 disposed along the X-axis direction, two slide members 87 provided on the two guide rails 86 so as to be slidable, and a drive system for driving the slide members 87 in the X-axis direction. Further, the imaging-unit-moving mechanism 85 includes a support frame 88 that is bridged across the two slide members 87 so as to cross over the conveying unit 70. The support frame 88 supports the imaging unit 80 so as to be movable in the Y-axis direction and includes a drive system for driving the imaging unit 80 in the Y-axis direction.

The imaging unit 80 is movable in the X and Y directions within a gap between the screen 10 and the substrate 8. The imaging unit 80 includes a first camera and a second camera. The first camera is directed upward to image the alignment marks 14 provided to the lower surface of the screen 10 from below. The second camera is directed downward to image alignment marks 9 provided on an upper surface of the substrate 8 from above. The alignment marks 9 of the substrate 8 are provided at any two or more positions on the substrate 8.

On the up-and-down base 60, the cleaning unit 90 and the cleaning-unit-moving mechanism 95 that moves the cleaning unit 90 in the X-axis direction are provided. The cleaning-unit-moving mechanism 95 includes the two guide rails 86 commonly used with the imaging-unit-moving mechanism 85, slide members 97 provided on the two guide rails 86 so as to be slidable, and a drive system for driving the slide members 97 in the X-axis direction. Further, the cleaning-unit-moving mechanism 95 includes a support frame 98 that is bridged across the two slide members 97 so as to cross over the conveying unit 70. The support frame 98 supports the cleaning unit 90 from below.

The cleaning unit 90 includes a feed roller 91 that feeds cleaning paper 93 and a take-up roller 92 that takes up the cleaning paper 93.

The controller 1 is constituted of, for example, a CPU (Central Processing Unit) and controls respective units of the screen printing apparatus 100 collectively. The processing of the controller 1 will be described later in detail.

The storage unit 2 includes a non-volatile memory used as a work area of the controller 1 and a non-volatile memory in which various types of data and programs that are used for processing of the controller 1 are stored. The various types of programs described above may be read from portable recording media such as an optical disc and a semiconductor memory.

The display unit 3 is constituted of, for example, a liquid crystal display. The input unit 4 is constituted of a keyboard, a mouse, a touch panel, and the like and receives inputs of various instructions from an operator. The communication unit 5 transmits information to other apparatuses such as a printing inspection apparatus and a mounting apparatus or receives information from other apparatus.

(Description on Operation)

Next, an operation of the screen printing apparatus 100 will be described. Here, an operation of the screen printing apparatus 100 to be described is executed under the control of the controller 1.

(Basic Operation)

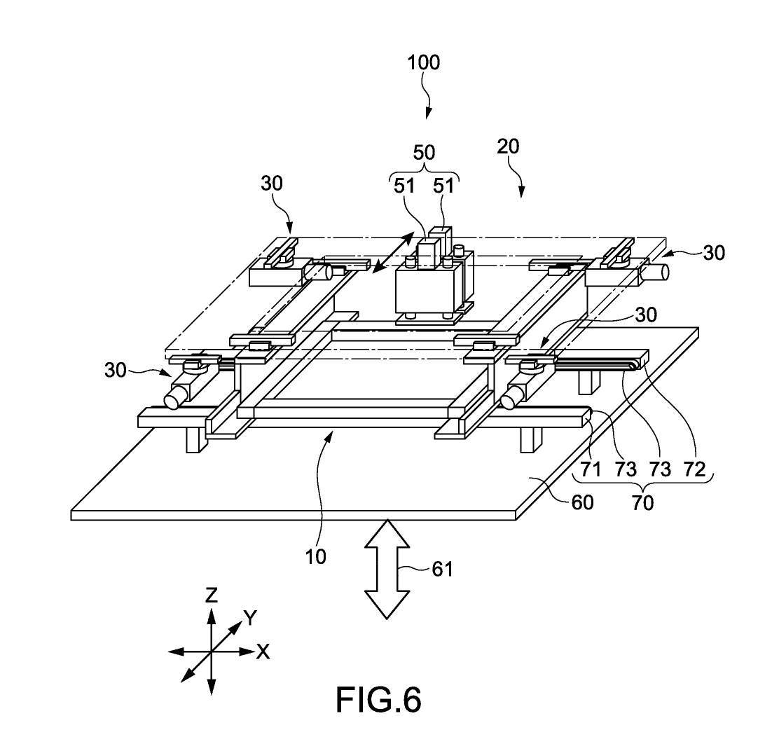

First, a basic operation of the screen printing apparatus 100 will be described. FIGS. 5 and 6 are perspective views for describing a basic operation of the screen printing apparatus 100.

With reference to FIG. 5, the substrate 8 is conveyed to a reference position by the drive of the conveyer belts 73 of the conveying unit 70. It should be noted that at that time, as shown in FIG. 5, the imaging unit 80 is moved to a right end position (standby position) of the up-and-down base 60 by the imaging-unit-moving mechanism 85 and holds standby in this state. Further, the cleaning unit 90 is moved to a left end position (standby position) of the up-and-down base 60 by the cleaning-unit-moving mechanism 95 and holds standby in this state.

Next, the back-up unit 79 is moved upward so that the substrate 8 is supported from below. Then, the second guide 72 of the conveying unit 70 is moved toward the front side in the Y-axis direction, and the substrate 8 is sandwiched between the first guide 71 and the second guide 72. Thus, the position of the substrate 8 is fixed.

Next, the imaging unit 80 is moved in the X and Y directions by the imaging-unit-moving mechanism 85 so that the (two or more) alignment marks 9 provided on the substrate 8 are imaged with use of the second camera (directed downward). The imaging unit 80 transmits the images of the alignment marks 9 to the controller 1. When the imaging of the alignment marks 9 of the substrate 8 is completed, the imaging unit 80 is moved to the standby position (right end position of the up-and-down base 60) by the imaging-unit-moving mechanism 85.

The controller 1 receives the images of the alignment marks 9 of the substrate 8, which are transmitted from the imaging unit 80, and recognizes a position in the X and Y directions at which the substrate 8 is disposed, an inclination of the substrate 8 about the Z-axis direction, and the like based on the received images of the alignment marks 9. When recognizing the position of the substrate 8, the controller 1 drives the table driving unit 30 to move the table 25 in the X, Y, and θ directions. Thus, the screen 10 is moved in the X, Y, and θ directions and the position of the screen 10 is aligned with the position of the substrate 8.

It should be noted that in order to align the position of the screen 10 with the position of the substrate 8, it is necessary for the controller 1 to recognize the position of the screen 10 in advance. The position of the screen 10 is recognized when the screen 10 is replaced, as will be described later.

After the position of the screen 10 is aligned with the position of the substrate 8, the up-and-down mechanism 61 moves the up-and-down base 60 upward so that the substrate 8 comes into contact with the lower surface of the screen 10. FIG. 6 shows a state in which the up-and-down base 60 is moved upward. In FIG. 6, in order to be easily viewable, the members such as the imaging unit 80 and the cleaning unit 90 are not illustrated.

When the substrate 8 comes into contact with the lower surface of the screen 10, one of the two squeegee mechanisms 51 is moved downward and comes into contact with the screen 10. Which of the squeegee mechanisms 51 is moved downward is determined in advance in accordance with the direction in which the squeegee unit 50 is moved. It should be noted that the other squeegee mechanism 51 is not in contact with the screen 10.

When the one squeegee mechanism 51 comes into contact with the screen 10, the two squeegee mechanisms 51 are integrally moved in the Y-axis direction. Thus, the one squeegee mechanism 51 slides on the screen 10 in the Y-axis direction so that cream solder is printed on the substrate 8 via the patterned holes 13. When the squeegee unit 50 is moved to a position near the edge of the screen 10, the one squeegee mechanism 51 brought into contact with the substrate 8 is moved upward, and the squeegee unit 50 holds standby in this state.

When cream solder is printed on the substrate 8, the up-and-down mechanism 61 moves the up-and-down base 60 downward. Upon downward movement of the up-and-down base 60, the second guide 72 (on the rear side) of the conveying unit 70 is moved to the rear side by a predetermined amount so that the fixed state of the substrate 8 is released. Then, the conveyer belts 73 of the conveying unit 70 are driven, and the substrate 8 on which printing is completed is transferred to a printing inspection apparatus on the downstream side.

Here, in the case where the lower surface of the screen 10 is intended to be cleaned, the up-and-down mechanism 61 first adjusts the height of the cleaning unit 90. After that, the cleaning unit 90 is moved in the X-axis direction by the cleaning-unit-moving mechanism 95. In conjunction with the movement of the cleaning unit 90 in the X-axis direction, the feed roller 91 and the take-up roller 92 are rotated. Thus, the cleaning paper 93 cleans the lower surface of the screen 10.

When the cleaning is finished, the cleaning unit 90 is moved to the standby position (left end position of the up-and-down base 60) by the cleaning-unit-moving mechanism 95 and holds standby at the standby position.

(Operation at Replacement of Screen 10)

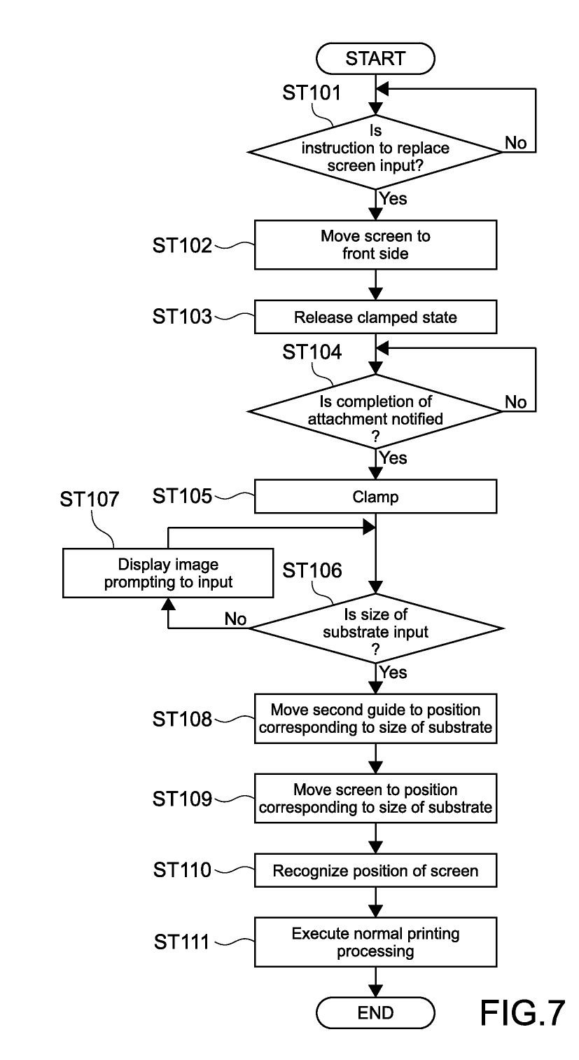

Next, an operation of the screen printing apparatus 100 at the time when the screen 10 is replaced will be described including an operation by an operator. FIG. 7 is a flowchart of an operation of the screen printing apparatus 100 when the screen 10 is replaced.

The controller 1 determines whether an instruction to replace the screen 10 is input or not (Step 101). When replacing the screen 10, an operator inputs an instruction to replace the screen 10 to the screen printing apparatus 100 via the input unit 4.

Upon input of an instruction to replace the screen 10 (YES of Step 101), the controller 1 controls the table driving unit 30 to move the screen 10 to the front side of the screen printing apparatus 100 (Step 102). It should be noted that when the screen 10 is moved to the front side, the squeegee unit 50 is also moved to the front side integrally in accordance with the movement of the table 25. When the screen 10 is moved to the front side, the controller 1 controls the cylinder of the clamping member, which fixes the screen 10 to the screen holding members 21, to release a clamped state of the screen 10 by the clamping member (Step 103).

Upon release of the clamped state of the screen 10, the operator holds the screen 10 and pulls the screen 10 toward the front side. Thus, the screen 10 slides on the lower plates 23 of the screen holding members 21 and is detached from the screen holding members 21.

Next, the operator attaches a screen 10, which corresponds to a substrate 8 on which printing is newly performed, to the screen holding members 21. The screen 10 newly attached to the screen holding members 21 differs from the screen 10 originally attached to the screen holding members 21 in pattern shape of the patterned holes 13. Further, the screen 10 newly attached may be a screen 10 corresponding to a substrate 8 that is different in size from the substrate 8 as the original printing target. In addition, the screen 10 newly attached may be different in the entire size from the screen 10 originally attached.

In the case where the entire size (X-axis direction) of the screen 10 is different from that of the original screen 10, it is necessary for the operator to adjust a distance between the two screen holding members 21. In this case, the operator inputs an instruction into the screen printing apparatus 100 via the input unit 4 so that the distance between the two screen holding members 21 is adjusted by the width adjusting mechanism 26.

When the screen 10 is attached to the screen holding members 21, the operator places a rear end side of the screen 10 on the lower plates 23 of the screen holding members 21 and thereafter pushes the screen 10 toward the deep side. Thus, the screen 10 slides on the lower plates 23 of the screen holding members 21 to be moved to an attachment position. The attachment position of the screen 10 to the screen holding members 21 is set in advance in accordance with the type (size) of the screen 10.

Next, the operator inputs the size of the substrate 8 into the screen printing apparatus 100 via the input unit 4. Then, the operator transmits information indicating that the attachment of the screen 10 to the screen holding members 21 is completed, via the input unit 4.

After releasing the clamped state of the screen 10 by the clamping member, the controller 1 determines whether the completion of the attachment of the screen 10 to the screen holding members 21 is received (Step 104). Upon reception of the attachment completion, the controller 1 then controls the cylinder of the clamping member to fix the screen 10 to the screen holding members 21 (Step 105).

Next, the controller 1 determines whether the size of the substrate 8 is input or not (Step 106). In the case where the size of the substrate 8 is not input (NO of Step 106), the controller 1 causes the display unit 3 to display, on its screen, an image that prompts the operator to input the size of the substrate 8 (Step 107). Upon display of the image to prompt the operator to input the size of the substrate 8 on the screen, the controller 1 determines again whether the size of the substrate 8 is input or not (Step 106).

In the case where the size of the substrate 8 is input (YES of Step 106), the controller 1 controls the guide moving mechanism 75 to move the second guide 72 (on the rear side) of the conveying unit 70 to a position corresponding to the size of the substrate 8 (Step 108). A relation between the size of the substrate 8 and the position of the second guide 72 is tabulated in advance and then stored in the storage unit 2. The controller 1 adjusts the position of the second guide 72 based on the table. For example, it is assumed that a substrate 8 having the width of 15 cm (Y-axis direction) is replaced with a substrate 8 having the width of 35 cm. In this case, the second guide 72 is moved by 20 cm toward the rear side.

Then, the controller 1 controls the screen moving mechanism 20 (table driving unit 30) to move the screen 10 to a position corresponding to the size of the substrate 8 (Step 109). A relation between the size of the substrate 8 and the position of the screen 10 (particularly, in the Y-axis direction) is tabulated in advance and then stored in the storage unit 2. The controller 1 reads the table and moves the screen 10 to a position corresponding to the size of the substrate 8.

For example, it is assumed that a substrate 8 having the width (Y-axis direction) of 15 cm is replaced with a substrate 8 having the width of 35 cm. In this case, the position of the screen 10 after the replacement is shifted by 10 cm (=(35 cm⁻¹⁵ cm)/2) toward the rear side from the position of the screen 10 before the replacement.

The processing of Step 108 and the processing of Step 109 may be performed in reverse order or may be executed at the same time.

After the screen 10 is moved to the position corresponding to the size of the substrate 8, the controller 1 moves the imaging unit 80 in the X and Y directions by the imaging-unit-moving mechanism 85. Then, the controller 1 moves the imaging unit 80 to a position below the (two) alignment marks 14 of the screen 10 and images the alignment marks 14 at the respective positions by the first camera directed upward. Then, the controller 1 recognizes the position of the screen 10 (patterned holes 13) based on those images (Step 110). After that, the controller 1 executes normal printing processing (processing described in the part of “Basic Operation”) (Step 111).

(Action etc.)

As described above, in the screen printing apparatus 100 according to this embodiment, the screen 10 can be automatically moved to an appropriate position corresponding to the size of the substrate 8. Thus, time and effort for position adjustment of the screen 10 by the operator can be omitted, thus improving user-friendliness. Further, compared with the case where the position of the screen 10 is adjusted manually, it is possible to move the screen 10 to a correct position.

In addition, since this embodiment is configured such that the screen 10 can be automatically moved to an appropriate position corresponding to the size of the substrate 8, the screen 10 can be automatically moved in the wide range (particularly, in the Y-axis direction). Therefore, the screen 10 can be automatically moved toward the front side. In this case, the screen 10 can be moved to the front side, specifically, to at least a position where a substrate 8 with the minimum size is subjected to printing. Thus, operations such as replacement of the screen 10 and collection of cream solder on the screen 10 can be easily performed.

In addition, in this embodiment, when the screen 10 is moved to the front side, the squeegee unit 50 is also moved to the front side. Therefore, for example, the replacement of the squeegee unit 50 can also be easily performed.

### Second Embodiment

Next, a second embodiment of the present disclosure will be described. In the second embodiment and the following description, members having the same configurations and functions as those of the first embodiment described above will be denoted by the same reference symbols and description thereof will be omitted or simplified.

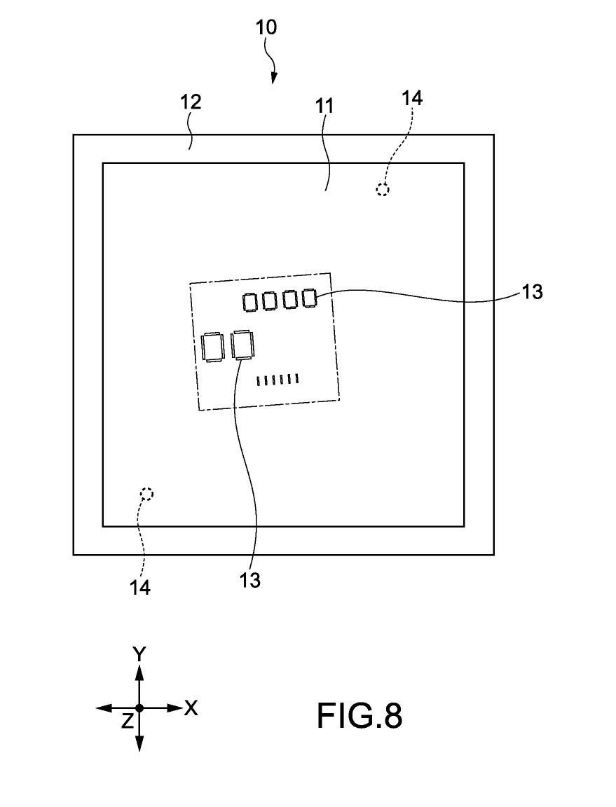

FIG. 8 is a top view showing another example of the screen 10. The patterned holes 13 of the screen 10 shown in FIG. 8 are shifted from the center position of the screen 10 and rotated about the Z-axis direction.

In the screen 10, ideally, the patterned holes 13 are correctly disposed at the center position of the screen 10, as shown in FIG. 2. In reality, however, the patterned holes 13 are formed at positions shifted from the center of the screen 10, as shown in FIG. 8. In other words, the positions of the patterned holes 13 with respect to the screen 10 are individually different.

The reason why such individual differences exist will be described. Normally, the screen 10 is manufactured in the following manner. First, press working is performed on a metal plate so that the screen body 11 including the patterned holes 13 and the alignment marks 14 is formed. The patterned holes 13 and the alignment marks 14 are integrally formed by press working, and therefore there are few individual differences in positional relation between the patterned holes 13 and the alignment marks 14.

After that, the screen frame body 12 is prepared, and the screen body 11 is fixed to a lower position of the screen frame body 12. However, it is difficult to correctly fix the screen body 11 to the screen frame body 12. For that reason, individual differences occur at the positions of the patterned holes 13 with respect to the screen 10.

In this regard, processing of eliminating the influence of such individual differences in position of the patterned holes 13 with respect to the screen 10 is executed in the second embodiment.

(Description on Operation)

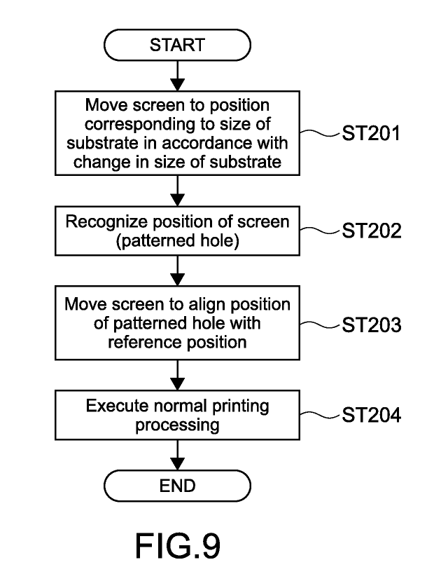

Next, an operation of the screen printing apparatus 100 according to the second embodiment will be described. FIG. 9 is a flowchart of an operation of the screen printing apparatus 100 according to the second embodiment.

First, the controller 1 controls the screen moving mechanism 20 to move the screen 10 to a position corresponding to the size of the substrate 8, in accordance with a change in size of the substrate 8 (Step 201). The processing of Step 201 is the same as that of Steps 101 to 109 shown in FIG. 7.

After the screen 10 is moved to the position corresponding to the size of the substrate 8, the controller 1 moves the imaging unit 80 in the X and Y directions by the imaging-unit-moving mechanism 85. Then, the controller 1 moves the imaging unit 80 to a position below the (two) alignment marks 14 of the screen 10 and images the alignment marks 14 at the respective positions by the first camera directed upward. Then, the controller 1 recognizes the positions of the patterned holes 13 of the screen 10 based on those images (Step 202). Since there are few individual differences in positions of the patterned holes 13 with respect to the positions of the alignment marks 14, the controller 1 can correctly recognize the positions of the patterned holes 13.

Next, the controller 1 moves the screen 10 by the screen moving mechanism 20 and aligns the positions at which the patterned holes 13 are provided, with a reference position that is a reference at which the substrate 8 is disposed (Step 203). The reference position at which the substrate 8 is disposed is set in advance in accordance with the size of the substrate 8. A relation between the size of the substrate 8 and the reference position is tabulated and stored in the storage unit 2.

In Step 203, the controller 1 reads this table from the storage unit 2 and recognizes the reference position corresponding to the size of the substrate 8. Then, the controller 1 calculates a shift amount between the positions of the patterned holes 13 and the reference position and determines to what extent the screen 10 is to be moved in the X, Y, and θ directions. Then, the controller 1 moves the screen 10 by the screen moving mechanism 20 and executes the alignment described above.

After the alignment, the controller 1 executes the same processing as normal processing (Step 204). For example, the controller 1 loads the substrate 8, fixes the substrate 8 at the reference position, and images the alignment marks 9 of the substrate 8 fixed at the reference position. Further, the controller 1 moves the screen 10 in the X, Y, and θ directions based on the images of the alignment marks 9 of the substrate 8 and aligns the position of the substrate 8 with the position of the screen 10 (the positions of the patterned holes 13).

(Action etc.)

An action of the second embodiment will be described while comparing the alignment of the patterned holes 13 with respect to the substrate 8 by the screen printing apparatus 100 according to the second embodiment and an alignment of patterned holes 13 with respect to a substrate 8 by a screen printing apparatus 100 according to a comparative example.

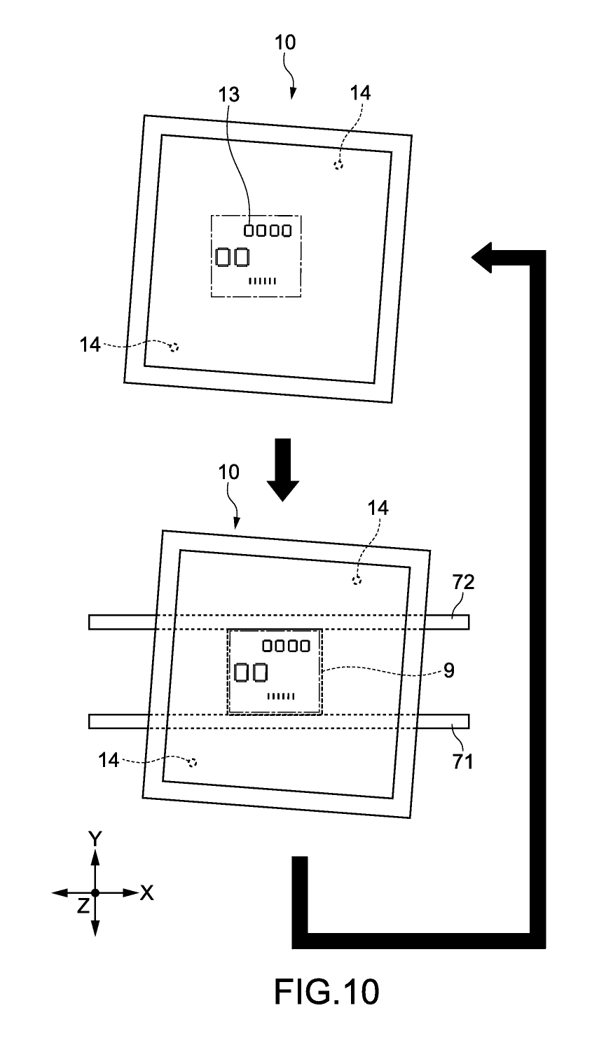

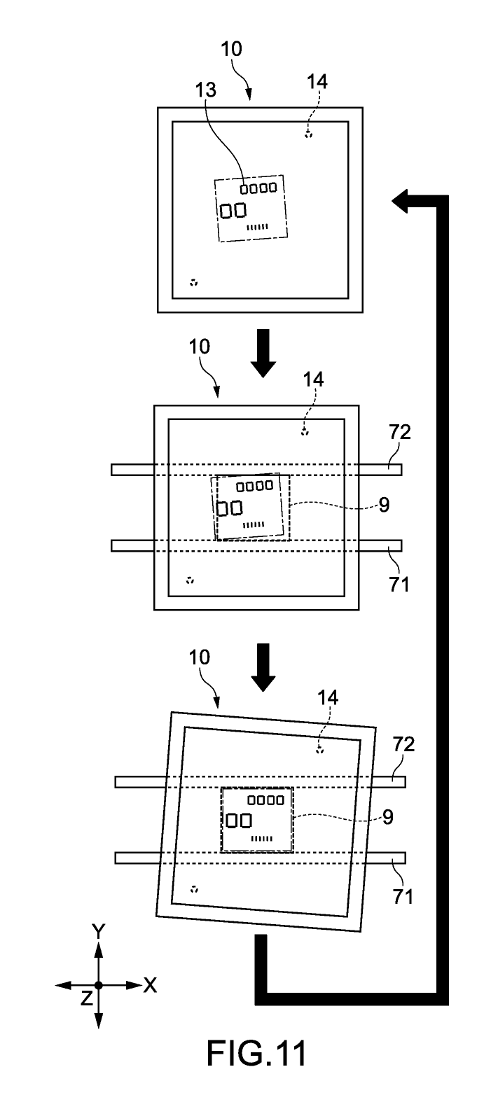

FIG. 10 is a diagram for describing an alignment by the screen printing apparatus 100 according to the second embodiment. FIG. 11 is a diagram for describing an alignment by a screen printing apparatus 100 according to a comparative example.

First, with reference to FIG. 11, an alignment by a screen printing apparatus 100 according to a comparative example will be described. In the comparative example shown in FIG. 11, the alignment of the patterned holes 13 with respect to the reference position is not performed. The patterned holes 13 are directly aligned with the position of the substrate 8.

With reference to the upper part of FIG. 11, the screen 10 holds standby in a state where the positions of the patterned holes 13 are shifted from the reference position. With reference to the middle part of FIG. 11, the substrate 8 is conveyed to the reference position and fixed at this position. It should be noted that the position of the substrate 8 at that time is slightly shifted from the reference position. Next, the second camera (directed downward) of the imaging unit 80 images the alignment marks 14 on the substrate 8. The controller 1 recognizes the position of the substrate 8 based on those images.

Upon recognition of the position of the substrate 8, the controller 1 calculates a shift amount between the position of the substrate 8 and the positions of the patterned holes 13 of the screen 10. Then, the controller 1 moves the screen 10 by the screen moving mechanism 20 and aligns the positions of the patterned holes 13 with the position of the substrate 8 (see the lower part of FIG. 11).

Upon completion of the alignment, the substrate 8 comes into contact with the lower surface of the screen 10 so that cream solder is printed on the substrate 8. Upon completion of the printing, the screen 10 is returned to the original position (see the upper part of FIG. 11). The screen 10 waits until the next substrate 8 is loaded in a state where the positions of the patterned holes 13 are shifted from the reference position.

In the comparative example, a correction of a positional shift amount of the patterned holes 13 with respect to the reference position and a correction of a positional shift amount of the actual position of the substrate 8 with respect to the reference position are executed for each substrate 8 in each case. Therefore, when the positions of the patterned holes 13 are aligned with the position of the substrate 8, extra time is unnecessarily spend.

Next, with reference to FIG. 10, description will be given on an alignment by the screen printing apparatus 100 according to the second embodiment. With reference to the upper part of FIG. 10, the screen 10 holds standby in a state where the positions of the patterned holes 13 are aligned with the reference position (see Step 203 of FIG. 9).

With reference to the lower part of FIG. 10, the substrate 8 is conveyed to the reference position and fixed at this position. Next, the second camera (directed downward) of the imaging unit 80 images the alignment marks 14 on the substrate 8, and the controller 1 recognizes the position of the substrate 8.

Upon recognition of the position of the substrate 8, the controller 1 moves the screen 10, for which the positions of the patterned holes 13 are already aligned with the reference position, and aligns the positions of the patterned holes 13 with the position of the substrate 8. Upon completion of the alignment, the controller 1 causes the substrate 8 to come into contact with the lower surface of the screen 10 so that cream solder is printed on the substrate 8. Upon completion of the printing, the controller 1 moves the screen 10 to the original position (see the upper part of FIG. 10). The screen 10 holds standby until the next substrate 8 is loaded in this state.

In the second embodiment, unlike the comparative example, the screen 10 holds standby in a state where the positions of the patterned holes 13 are aligned with the reference position. Therefore, when the patterned holes 13 are aligned with the actual position of the substrate 8, it is unnecessary to correct a positional shift amount of the patterned holes 13 with respect to the reference position. In other words, by only a correction of a positional shift amount of the actual position of the substrate 8 with respect to the reference position, the patterned holes 13 can be aligned with the position of the substrate 8. Thus, it is possible to appropriately eliminate the influence of the individual differences in positions of the patterned holes 13 and shorten time spent for printing of the substrate 8.

### Third Embodiment

Next, a screen printing apparatus 100 according to a third embodiment of the present disclosure will be described. In the screen printing apparatus 100 according to the third embodiment, a screen moving mechanism 120 for moving the screen 10 is different in configuration from the screen moving mechanism 20 described in the above embodiments.

(Configuration of Screen Moving Mechanism 120)

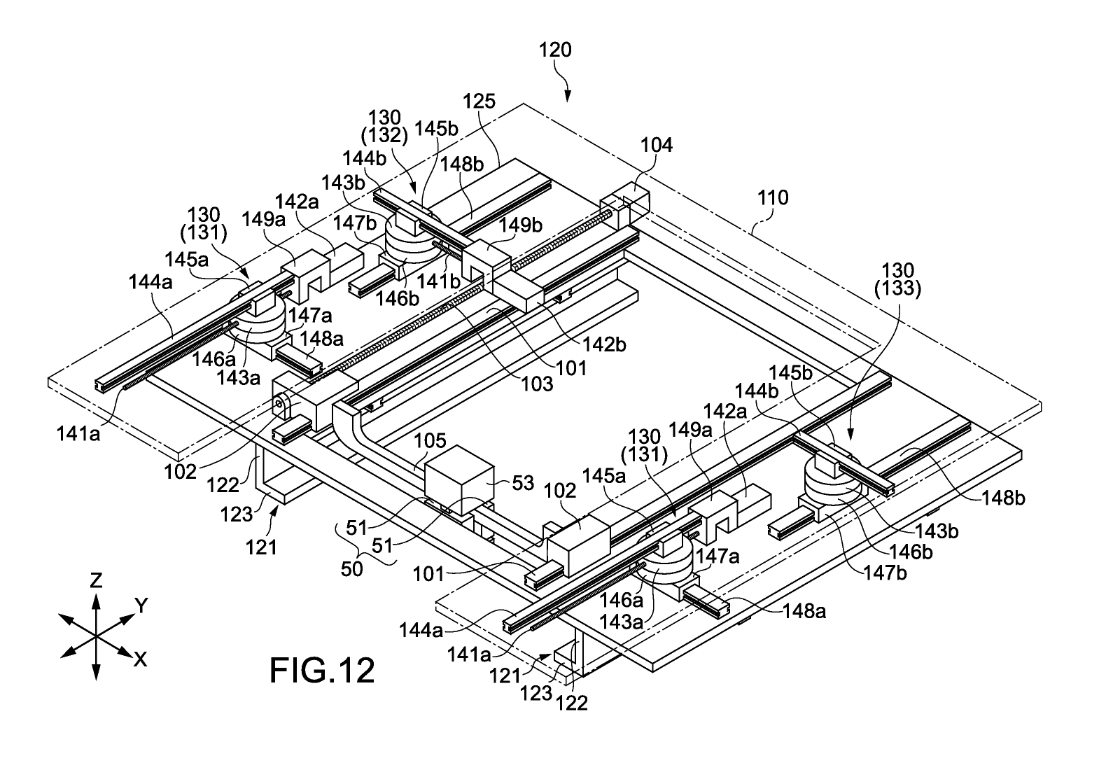

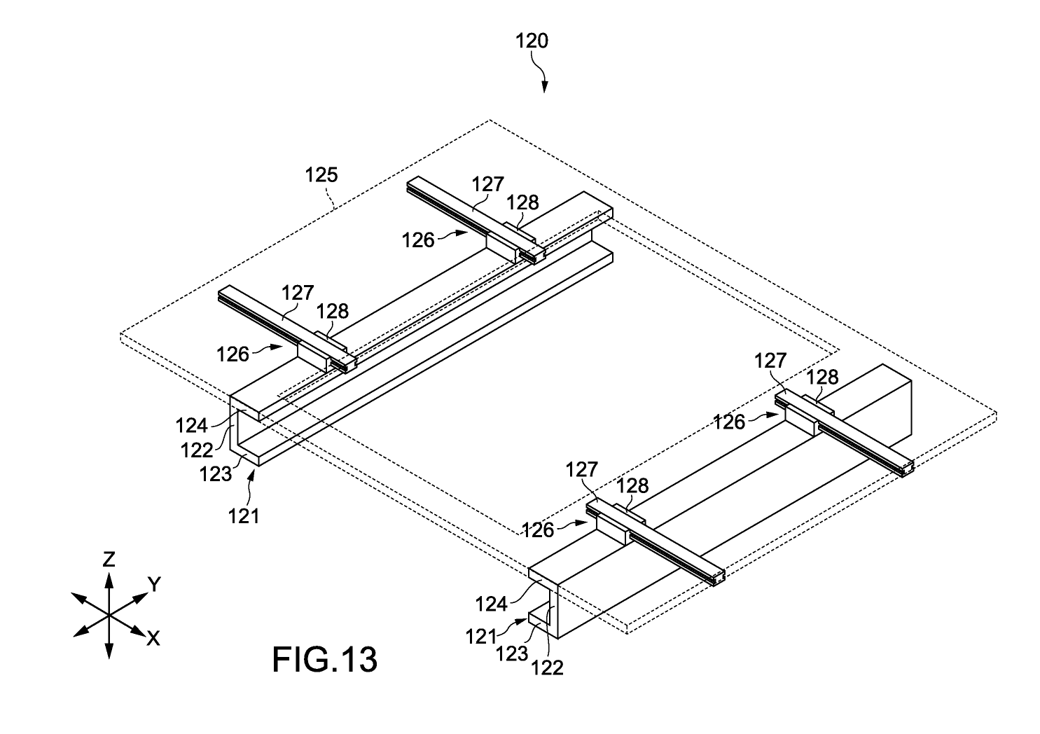

FIGS. 12 and 13 are perspective views each showing the screen moving mechanism 120 of the screen printing apparatus 100 according to the third embodiment. FIG. 12 shows a state where a table 125 and members provided on the table 125 are seen obliquely from above. It should be noted that in FIG. 12, a plate member 110 located above the table 125 is indicated by a dashed line. Meanwhile, FIG. 13 shows a state where members provided under the table 125 are seen obliquely from above, and the table 125 is indicated by a broken line.

In the screen moving mechanism 20 according to the embodiments described above, the table driving unit 30 for driving the table 25 in the X, Y, and θ directions is disposed on the lower side of the table 25. On the other hand, in the screen moving mechanism 120 according to the third embodiment, a table driving unit 130 is disposed on the upper side of the table 125. Therefore, this difference will be mainly described. It should be noted that members having basically the same configurations and functions as those of the embodiments described above will be denoted by the same reference symbols and description thereof will be omitted or simplified.

As shown in FIGS. 12 and 13, the screen moving mechanism 120 includes the table 125 and a pair of screen holding members 121. The pair of screen holding members 121 are provided so as to face each other in the X-axis direction (width direction) on the lower side of the table 125 and holds the screen 10. Further, the screen moving mechanism 120 includes a width adjusting mechanism 126 that is located between the table 125 and the screen holding members 121 and adjusts a distance between the screen holding members 21 as a pair in the X-axis direction (width direction). In addition, the screen moving mechanism 120 includes the table driving unit 130 that is provided on the upper side of the table 125 and drives the table 125 in the X, Y, and θ directions.

The table 125 is a flat member having a rectangular shape in plan view and has an opening at the center position thereof, in which the squeegee unit 50 is disposed.

The screen holding members 121 have basically the same configurations as the screen holding members 21 described above. Specifically, each of the screen holding members 121 as a pair includes a side plate 122, a lower plate 123, and an upper plate 124. The lower plate 123 is attached vertically to the side plate 122 at a lower position of the side plate 122. The upper plate 124 is attached vertically to the side plate 122 at an upper position of the side plate 122.

Basically, the width adjusting mechanism 126 also has the same configuration as the width adjusting mechanism 26 described above. The width adjusting mechanism 126 includes two guide rails 127 (width adjusting rails) for moving one of the screen holding members 121 in the X-axis direction and two guide rails 127 (width adjusting rails) for moving the other screen holding member 121 in the X-axis direction. Further, the width adjusting mechanism 126 includes four slide members 128 that are movable along those four guide rails 127.

The four guide rails 127 are fixed on the lower surface of the table 125 along the X-axis direction. The four slide members 128 are fixed onto the upper plates 124 of the screen holding members 121, guided by the guide rails 127, and moved along the X-axis direction. The width adjusting mechanism 126 includes a drive system such as a ball screw mechanism (not shown), and by the drive of the drive system, the slide members 128 are moved along the X-axis direction. Thus, the distance between the screen holding members 121 is automatically adjustable.

It should be noted that in the third embodiment, the table driving unit 130 is disposed on the upper side of the table 125, and the width adjusting mechanism 126 does not interfere with the table driving unit 130. Therefore, the guide rails 127 of the width adjusting mechanism 126 can be lengthened. Thus, a moving distance of the pair of screen holding members 121 in the X-axis direction can be increased.

On the upper side of the table 125, near the opening that is provided at the center of the table 125, two squeegee driving rails 101 are provided along the Y-axis direction so as to sandwich the opening. The two squeegee driving rails 101 are each provided with a movable body 102 that is movable along the squeegee driving rail 101 in the Y-axis direction.

A carriage 105 is bridged across the two movable bodies 102 along the X-axis direction. The squeegee unit 50 is attached to the carriage 105 via a support body 53 attached to the upper portion of the squeegee unit 50.

Near one of the squeegee driving rails 101 (left side in FIG. 12), a ball screw shaft 103 is provided along the Y-axis direction. The ball screw shaft 103 is connected to a motor 104 that is disposed near the end portion of the table 125 on the rear side. The ball screw shaft 103 is rotatable in accordance with the drive of the motor 104. One of the two movable bodies 102 that are movable on the squeegee driving rails 101 (left-side one in FIG. 12) incorporates a ball screw nut that engages with the ball screw shaft 103.

When the motor 104 is driven, the ball screw shaft 103 is rotated, and the one movable body 102 that incorporates the ball screw nut engaging with the ball screw shaft 103 is guided by the squeegee driving rail 101 to be moved in the Y-axis direction. Along with the movement of the one movable body 102, the other movable body 102 (right-side one in FIG. 12) is also guided by the squeegee driving rail 101 to be moved in the Y-axis direction. Along with the movement of the two movable bodies 102 in the Y-axis direction, the carriage 105 is moved along the Y-axis direction, and the squeegee unit 50 attached to the carriage 105 is moved along the Y-axis direction.

The table driving unit 130 includes two Y-axis drive mechanisms 131 (second table drive mechanism), one X-axis drive mechanism 132 (first table drive mechanism), and one interlocking mechanism 133. Those four mechanisms 131, 132, and 133 are provided on the upper side of the table 125. Further, the four drive mechanisms 131, 132, and 133 are provided on the lower side of the plate member 110 that is fixed to the main body of the screen printing apparatus (see a dashed line in FIG. 12).

The plate member 110 is a flat member formed of a metal plate, for example. In the example shown in FIG. 12, the plate member 110 has an inverse U-shape in plan view. The shape of the plate member 110 is not particularly limited as long as the four drive mechanisms 131, 132, and 133 can be attached thereto.

The two Y-axis drive mechanisms 131 are disposed on the right and left sides at the front of the table 125. The X-axis drive mechanism 132 is disposed on the left, rear side of the table 125, and the interlocking mechanism 133 is disposed on the right, rear side of the table 125. It should be noted that the positions where those four drive mechanisms are disposed can be changed as appropriate. For example, the two Y-axis drive mechanisms 131 may be disposed on the rear side, and the X-axis drive mechanism 132 and the interlocking mechanism 133 may be disposed on the front side of the table 125. Alternatively, the X-axis drive mechanism 132 and the interlocking mechanism 133 may be positioned vice versa.

The two Y-axis drive mechanisms 131 support the table 125 from above and move the table 125 in the Y-axis direction by the drive of the two Y-axis drive mechanisms 131. The X-axis drive mechanism 132 supports the table 125 from above and moves the table 125 in the X-axis direction by the drive of the X-axis drive mechanism 132. Further, the Y-axis drive mechanisms 131 and the X-axis drive mechanism 132 can rotate the table 125 about the Z-axis direction (A direction) by the interlock of those drive mechanisms.

It should be noted that the interlocking mechanism 133 does not include a motor for moving the table 125. The interlocking mechanism 133 supports the table 125 from above and operates in conjunction with the drive of the table 125 by the Y-axis drive mechanisms 131 and the X-axis drive mechanism 132.

The two Y-axis drive mechanisms 131 have the same configuration. Each of the two Y-axis drive mechanisms 131 includes a guide rail 148a (third table driving rail) and a slide member 147a (third slide member). The guide rail 148a is fixed to the upper surface of the table 125 along the X-axis direction (width direction). The slide member 147a is slidable along the guide rail 148a. Further, the Y-axis drive mechanism 131 includes a guide rail 144a (fourth table driving rail) and a slide member 145a (fourth slide member). The guide rail 144a is fixed to the lower surface of the plate member 110 along the Y-axis direction (perpendicular direction). The slide member 145a is slidable along the guide rail 144a.

Further, the Y-axis drive mechanism 131 includes a rotating body 146a that can relatively rotate the slide member 147a and the slide member 145a. In addition, the Y-axis drive mechanism 131 includes a ball screw shaft 141a, a motor 142a, and a ball screw nut unit 143a. The ball screw shaft 141a is provided along the Y-axis direction. The motor 142a serves as a drive source that rotates the ball screw shaft 141a. The ball screw nut unit 143a incorporates a ball screw nut that engages with the ball screw shaft 141a.

The ball screw nut unit 143a is fixed to the lower side of the slide member 145a. The rotating body 146a is located between the ball screw nut unit 143a and the slide member 147a and connects the ball screw nut unit 143a and the slide member 147a to each other so as to be rotatable. The motor 142a is fixed to a motor support unit 149a. The motor support unit 149a is fixed to the lower side of the plate member 110.

As shown in FIG. 12, the guide rail 144a fixed to the lower surface of the plate member 110 along the Y-axis direction is longer than the guide rail 148a fixed to the upper surface of the table 125 along the X-axis direction. This is because, as described above, the screen 10 is intended to be automatically moved to an appropriate position corresponding to the size of the substrate 8 by being moved over a wide range in the Y-axis direction. Further, this is because, by being moved over a wide range in the Y-axis direction, the screen 10 is intended to be moved to a position near the front side of the screen printing apparatus 100 and thus the replacement or cleaning of the screen 10 can be easily performed.

The X-axis drive mechanism 132 is different from the Y-axis drive mechanism 131 in the orientation to be arranged and the length of the guide rails 148 and 144, but the basic configuration thereof is the same as that of the Y-axis drive mechanism 131.

Specifically, the X-axis drive mechanism 132 includes a guide rail 148b (first table driving rail) and a slide member 147b (first slide member). The guide rail 148b is fixed to the upper surface of the table 125 along the Y-axis direction (perpendicular direction). The slide member 147b is slidable along the guide rail 148b. Further, the X-axis drive mechanism 132 includes a guide rail 144b (second table driving rail) and a slide member 145b (second slide member). The guide rail 144b is fixed to the lower surface of the plate member 110 along the X-axis direction (width direction). The slide member 145b is slidable along the guide rail 144b.

Further, the X-axis drive mechanism 132 includes a rotating body 146b that can relatively rotate the slide member 147b and the slide member 145b. In addition, the X-axis drive mechanism 132 includes a ball screw shaft 141b, a motor 142b, and a ball screw nut unit 143b. The ball screw shaft 141b is provided along the X-axis direction. The motor 142b serves as a drive source that rotates the ball screw shaft 141b. The ball screw nut unit 143b incorporates a ball screw nut that engages with the ball screw shaft 141b.

The ball screw nut unit 143b is fixed to the lower side of the slide member 145b. The rotating body 146b is located between the ball screw nut unit 143b and the slide member 147b and connects the ball screw nut unit 143b and the slide member 147b to each other so as to be rotatable. The motor 142b is fixed to a motor support unit 149b. The motor support unit 149b is fixed to the lower side of the plate member 110.

The guide rail 148b of the X-axis drive mechanism 132, which is fixed to the upper surface of the table 125 along the Y-axis direction, has the same length as the guide rail 144a of the Y-axis drive mechanism 131, which is fixed to the lower surface of the plate member 110 along the Y-axis direction. Similarly, the guide rail 144b of the X-axis drive mechanism 132, which is fixed to the lower surface of the plate member 110 along the X-axis direction, has the same length as the guide rail 148a of the Y-axis drive mechanism 131, which is fixed to the upper surface of the table 125 along the X-axis direction.

The interlocking mechanism 133 has the same configuration as the X-axis drive mechanism 132 except the configuration in which the ball screw shaft 141b, the motor 142b, and the motor support unit 149b are not provided.

Next, an operation when the table 125 is moved in accordance with the drive of the table driving unit 130 will be simply described. For example, when the motor 142b of the X-axis drive mechanism 132 is driven in a state where the two Y-axis drive mechanisms 131 are not driven, the table 125 is moved in the X-axis direction. Further, when the two motors 142a of the two Y-axis drive mechanisms 131 are simultaneously rotated by the same amount in a state where the X-axis drive mechanism 132 is not driven, the table 125 is moved in the Y-axis direction. In the case where the two motors 142a of the two Y-axis drive mechanisms 131 are driven so as to have different rotation amounts and rotation directions, the table 125 is rotated about the Z-axis direction (A direction). When the table 125 is rotated about the Z-axis direction, the motor 142b of the X-axis drive mechanism 132 may be driven together with the motors 142a of the Y-axis drive mechanisms 131.

(Action etc.)

As described above, in the screen moving mechanism 120 of the screen printing apparatus 100 according to the third embodiment, the pair of screen holding members 121 and the width adjusting mechanism 126 are provided on the lower side of the table 125. Then, on the opposite, upper side of the table, the table driving unit 130 for driving the table is provided. Thus, it is possible to avoid the interference between the table driving unit 130 and the pair of screen holding members 121 and width adjusting mechanism 126. Thus, the screen printing apparatus 100 can be downsized with increase in a moving distance of the table 125 by the table driving unit 130 and a moving distance of the pair of screen holding members 121 by the width adjusting mechanism 126.

Here, with reference to the FIGS. 12 and 13, the guide rail 148b of the X-axis drive mechanism 132 and that of the interlocking mechanism 133, which are fixed to the upper surface of the table 125 along the Y-axis direction, are located at positions crossing via the table 125 with the guide rails 127 of the width adjusting mechanism 126, which are attached to the lower surface of the table 125.

Specifically, in the third embodiment, the interference between the table driving unit 130 and the pair of screen holding members 121 and width adjusting mechanism 126 is avoided as described above. Therefore, the guide rails 148b of the X-axis drive mechanism 132 and the interlocking mechanism 133, which are fixed to the upper surface of the table 125 along the Y-axis direction, can be lengthened, and the guide rails 127 of the width adjusting mechanism 126, which are fixed to the lower surface of the table 125 along the X-axis direction, can be lengthened. Then, the guide rails 148b of the X-axis drive mechanism 132 and the interlocking mechanism 133, and the guide rails 127 of the width adjusting mechanism 126 can be disposed at positions crossing each other on the upper and lower surface of the table 125. Thus, the screen printing apparatus 100 can be downsized with increase in a moving distance of the table 125 to the Y-axis direction by the table driving unit 130 and a moving distance of the pair of screen holding members 121 to the X-axis direction by the width adjusting mechanism 126.

Further, in the third embodiment, the two Y-axis drive mechanisms 131, the X-axis drive mechanism 132, and the interlocking mechanism 133 are directly attached to the upper surface of the table 125. In other words, a configuration in which the four drive mechanisms 131, 132, and 133 directly drive the table 125 is adopted. Thus, the drive of the table 125 to the X-axis, Y-axis, and O-axis directions can be easily controlled, and the drive accuracy of the table 125 can be improved.

### Various Modified Examples

As described above, since the configuration in which the screen 10 can be automatically moved to an appropriate position corresponding to the size of the substrate 8 is provided in the present disclosure, the screen 10 can be automatically moved over a wide range (particularly, in the Y-axis direction). Using this relation, a screen 10 with a big size (for example, large size) can be cleaned by cleaning paper with a small size (for example, medium size).

In the case where the screen 10 with a big size is cleaned using cleaning paper 93 with a small size, the controller 1 moves the screen 10 in the Y-axis direction (in a direction perpendicular to a direction in which the cleaning unit 90 moves) so that the screen 10 is disposed at two or more different positions. Then, in a state where the screen 10 is disposed at each of the two or more different positions, the controller 1 moves the cleaning unit 90 in the X-axis direction by the cleaning-unit-moving mechanism 95, to thereby clean the screen 10.

Through such processing, using the cleaning paper 93 with a small size, a screen 10 with any size can be cleaned.

In the embodiments as described above, the screen printing apparatus 100 that prints cream solder onto the substrate 8 has been described. On the other hand, the present disclosure can be applied to a screen printing apparatus 100 that prints an ink (paste-like material) on paper, a cloth, wood, plastic, and the like (printing substrate).

The present disclosure can take the following configurations.

(1) A screen printing apparatus, including:

a screen moving mechanism configured to move a screen including a patterned hole, the patterned hole being used for printing a paste-like material on a printing substrate; and

a controller configured to control the screen moving mechanism to move the screen to a position corresponding to a size of the printing substrate in accordance with a change in size of the printing substrate.

(2) The screen printing apparatus according to (1), in which

the controller is configured to move the screen to the position corresponding to the size of the printing substrate and then move the screen by the screen moving mechanism to align a position at which the patterned hole is provided, with a reference position serving as a reference at which the printing substrate is disposed.

(3) The screen printing apparatus according to (2),

in which the screen includes an alignment mark,

the screen printing apparatus further including an imaging unit capable of imaging the alignment mark of the screen,

in which the controller is configured to align the position at which the patterned hole is provided, with the reference position, based on an image of the alignment mark of the screen.

(4) The screen printing apparatus according to (2) or (3),

in which the printing substrate includes an alignment mark,

the screen printing apparatus further including an imaging unit capable of imaging the alignment mark of the printing substrate,

in which the controller is configured to move the screen based on an image of the alignment mark of the printing substrate, the position of the patterned hole of the screen being aligned with the reference position, and to align the position of the patterned hole with the position of the printing substrate.

(5) The screen printing apparatus according to any one of (1) to (4), further including:

a pair of guides configured to extend along a conveying direction in which the printing substrate is conveyed and to guide the printing substrate along the conveying direction; and

a guide moving mechanism configured to move at least one of the pair of guides in a direction perpendicular to the conveying direction, wherein

the controller is configured
to control the guide moving mechanism to move the at least one of the pair of guides in accordance with the change in size of the printing substrate, and
to control the screen moving mechanism to move the screen to the position corresponding to the size of the printing substrate.
   (6) The screen printing apparatus according to any one of (1) to (5), further including:

a cleaning unit configured to clean the screen; and

a cleaning-unit-moving mechanism configured to move the cleaning unit in a predetermined direction, wherein

the controller is configured
to move, when the screen is cleaned, the screen in a direction perpendicular to a direction in which the cleaning unit is moved, to dispose the screen at two or more different positions, and
to move the cleaning unit by the cleaning-unit-moving mechanism in the predetermined direction in a state where the screen is located at each of the two or more different positions to clean the screen.
   (7) The screen printing apparatus according to any one of (1) to (6), in which

the screen moving mechanism includes
a table,
a pair of screen holding members that are provided on a lower side of the table so as to face each other in a width direction and are configured to hold the screen,
a width adjusting mechanism that is located between the table and the pair of screen holding members and is configured to adjust a distance between the pair of screen holding members in the width direction, and
a table driving unit that is provided on an upper side of the table and is configured to drive the table.
   (8) The screen printing apparatus according to (7), in which

the width adjusting mechanism includes a width adjusting rail that is attached to a lower surface of the table along the width direction, and

the table driving unit includes a first table driving rail that is attached to an upper surface of the table along a perpendicular direction and is located at a position crossing the width adjusting rail on the upper side of the table, the perpendicular direction being perpendicular to the width direction, the width adjusting rail being attached to the lower surface of the table.

(9) The screen printing apparatus according to (8), further including a plate member that is provided above the table, in which

the table driving unit includes a first table drive mechanism including
the first table driving rail that is attached to the upper surface of the table along the perpendicular direction,
a first slide member that is slidable along the first table driving rail,
a second table driving rail that is attached to a lower surface of the plate member along the width direction,
a second slide member that is slidable along the second table driving rail, and
a rotating body configured to relatively rotate the first slide member and the second slide member.
   (10) The screen printing apparatus according to (9), in which

the table driving unit includes a second table drive mechanism including
a third table driving rail that is attached to the upper surface of the table along the width direction,
a third slide member that is slidable along the third table driving rail,
a fourth table driving rail that is attached to the lower surface of the plate member along the perpendicular direction,
a fourth slide member that is slidable along the fourth table driving rail, and
a rotating body configured to relatively rotate the third slide member and the fourth slide member.
   (11) A screen printing apparatus, including:

a screen moving mechanism configured to move a screen including a patterned hole, the patterned hole being used for printing a paste-like material on a printing substrate; and

a controller configured to move the screen by the screen moving mechanism to align a position at which the patterned hole is provided, with a reference position serving as a reference at which the printing substrate is disposed.

(12) A printed matter manufacturing method, including:

controlling a screen moving mechanism to move a screen to a position corresponding to a size of a printing substrate, the screen including a patterned hole used for printing a paste-like material on the printing substrate; and

moving a squeegee to slide on the screen, to print a paste-like material on the printing substrate.

(13) A printed matter manufacturing method, including:

moving a screen by a screen moving mechanism, the screen including a patterned hole used for printing a paste-like material on a printing substrate, to align a position at which the patterned hole is provided, with a reference position serving as a reference at which the printing substrate is disposed; and

moving a squeegee to slide on the screen, to print a paste-like material on the printing substrate.

(14) A substrate manufacturing method, including:

controlling a screen moving mechanism to move a screen to a position corresponding to a size of a substrate, the screen including a patterned hole used for printing cream solder on the substrate;

moving a squeegee to slide on the screen, to print the cream solder on the substrate; and

mounting an electronic component on the substrate on which the cream solder is printed.

(15) A substrate manufacturing method, including:

moving a screen by a screen moving mechanism, the screen including a patterned hole used for printing cream solder on a substrate, to align a position at which the patterned hole is provided, with a reference position serving as a reference at which the substrate is disposed;

moving a squeegee to slide on the screen, to print the cream solder on the substrate; and

mounting an electronic component on the substrate on which the cream solder is printed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A screen printing apparatus, comprising:
a screen moving mechanism configured to move a screen including a patterned hole, the patterned hole being used for printing a paste-like material on a printing substrate; and
a controller configured to control the screen moving mechanism to move the screen to a position corresponding to a size of the printing substrate in accordance with a change in size of the printing substrate.

2. The screen printing apparatus according to claim 1, wherein
the controller is configured to move the screen to the position corresponding to the size of the printing substrate and then move the screen by the screen moving mechanism to align a position at which the patterned hole is provided, with a reference position serving as a reference at which the printing substrate is disposed.

3. The screen printing apparatus according to claim 2,
wherein the screen includes an alignment mark,
the screen printing apparatus further comprising an imaging unit capable of imaging the alignment mark of the screen,
wherein the controller is configured to align the position at which the patterned hole is provided, with the reference position, based on an image of the alignment mark of the screen.

4. The screen printing apparatus according to claim 2,
wherein the printing substrate includes an alignment mark,
the screen printing apparatus further comprising an imaging unit capable of imaging the alignment mark of the printing substrate,
wherein the controller is configured to move the screen based on an image of the alignment mark of the printing substrate, the position of the patterned hole of the screen being aligned with the reference position, and to align the position of the patterned hole with the position of the printing substrate.

5. The screen printing apparatus according to claim 1, further comprising:
a pair of guides configured to extend along a conveying direction in which the printing substrate is conveyed and to guide the printing substrate along the conveying direction; and
a guide moving mechanism configured to move at least one of the pair of guides in a direction perpendicular to the conveying direction, wherein
the controller is configured
to control the guide moving mechanism to move the at least one of the pair of guides in accordance with the change in size of the printing substrate, and
to control the screen moving mechanism to move the screen to the position corresponding to the size of the printing substrate.

6. The screen printing apparatus according to claim 1, further comprising:
a cleaning unit configured to clean the screen; and
a cleaning-unit-moving mechanism configured to move the cleaning unit in a predetermined direction, wherein
the controller is configured
to move, when the screen is cleaned, the screen in a direction perpendicular to a direction in which the cleaning unit is moved, to dispose the screen at two or more different positions, and
to move the cleaning unit by the cleaning-unit-moving mechanism in the predetermined direction in a state where the screen is located at each of the two or more different positions to clean the screen.

7. The screen printing apparatus according to claim 1, wherein
the screen moving mechanism includes
a table,
a pair of screen holding members that are provided on a lower side of the table so as to face each other in a width direction and are configured to hold the screen,
a width adjusting mechanism that is located between the table and the pair of screen holding members and is configured to adjust a distance between the pair of screen holding members in the width direction, and
a table driving unit that is provided on an upper side of the table and is configured to drive the table.

8. The screen printing apparatus according to claim 7, wherein
the width adjusting mechanism includes a width adjusting rail that is attached to a lower surface of the table along the width direction, and
the table driving unit includes a first table driving rail that is attached to an upper surface of the table along a perpendicular direction and is located at a position crossing the width adjusting rail on the upper side of the table, the perpendicular direction being perpendicular to the width direction, the width adjusting rail being attached to the lower surface of the table.

9. The screen printing apparatus according to claim 8, further comprising a plate member that is provided above the table, wherein
the table driving unit includes a first table drive mechanism including
the first table driving rail that is attached to the upper surface of the table along the perpendicular direction,
a first slide member that is slidable along the first table driving rail,
a second table driving rail that is attached to a lower surface of the plate member along the width direction,
a second slide member that is slidable along the second table driving rail, and
a rotating body configured to relatively rotate the first slide member and the second slide member.

10. The screen printing apparatus according to claim 9, wherein
the table driving unit includes a second table drive mechanism including
a third table driving rail that is attached to the upper surface of the table along the width direction,
a third slide member that is slidable along the third table driving rail,
a fourth table driving rail that is attached to the lower surface of the plate member along the perpendicular direction,
a fourth slide member that is slidable along the fourth table driving rail, and
a rotating body configured to relatively rotate the third slide member and the fourth slide member.

11. A screen printing apparatus, comprising:
a screen moving mechanism configured to move a screen including a patterned hole, the patterned hole being used for printing a paste-like material on a printing substrate; and
a controller configured to move the screen by the screen moving mechanism to align a position at which the patterned hole is provided, with a reference position serving as a reference at which the printing substrate is disposed.

12. A printed matter manufacturing method, comprising:
controlling a screen moving mechanism to move a screen to a position corresponding to a size of a printing substrate, the screen including a patterned hole used for printing a paste-like material on the printing substrate; and
moving a squeegee to slide on the screen, to print a paste-like material on the printing substrate.

13. A printed matter manufacturing method, comprising:
moving a screen by a screen moving mechanism, the screen including a patterned hole used for printing a paste-like material on a printing substrate, to align a position at which the patterned hole is provided, with a reference position serving as a reference at which the printing substrate is disposed; and
moving a squeegee to slide on the screen, to print a paste-like material on the printing substrate.

14. A substrate manufacturing method, comprising:
controlling a screen moving mechanism to move a screen to a position corresponding to a size of a substrate, the screen including a patterned hole used for printing cream solder on the substrate;
moving a squeegee to slide on the screen, to print the cream solder on the substrate; and
mounting an electronic component on the substrate on which the cream solder is printed.

15. A substrate manufacturing method, comprising:
moving a screen by a screen moving mechanism, the screen including a patterned hole used for printing cream solder on a substrate, to align a position at which the patterned hole is provided, with a reference position serving as a reference at which the substrate is disposed;
moving a squeegee to slide on the screen, to print the cream solder on the substrate; and
mounting an electronic component on the substrate on which the cream solder is printed.
